(19) United States
(12) Patent Application Publication
(10) Pub. No.: US 2026/0141543 A1
(43) Pub. Date: May 21, 2026

(54) METHOD FOR ALIGNING SCANS OF ENVIRONMENTAL SENSORS

(71) Applicant: Robert Bosch GmbH, Stuttgart (DE)

(72) Inventors: David Oertel, Stockdorf (DE); Hans-Georg Raumer, Hildesheim (DE); Thorben Funke, Sarstedt (DE); Tobias Ritter, Hildesheim (DE)

(21) Appl. No.: 19/386,533

(22) Filed: Nov. 12, 2025

(30) Foreign Application Priority Data
Nov. 18, 2024 (DE) 10 2024 211 034.5

(51) Int. Cl. G06T 7/33; G01S 17/89

(52) U.S. Cl. CPC G06T 7/337; G01S 17/89; G06T 2207/10028; G06T 2207/20084; G06T 2207/20221

(57) ABSTRACT

A method for aligning scans of environmental sensors. In the method, scans of a first and a second environmental sensor are used. For each environmental sensor, a first scan recorded at a first point in time and a second scan of the same environment recorded at a second point in time following the first point in time are used. The first scan of the first environmental sensor and the first scan of the second environmental sensor are combined to form a first fused scan. The second scan of the first environmental sensor and the second scan of the second environmental sensor are combined to form a second fused scan. An aligning transformation between the first fused scan and the second fused scan is ascertained.

### CROSS REFERENCE

The present application claims the benefit under 35 U.S.C. § 119 of Germany Patent Application No. DE 10 2024 211 034.5 filed on Nov. 18, 2024, which is expressly incorporated herein by reference in its entirety.

### FIELD

The present invention relates to a method for aligning scans of environmental sensors.

### BACKGROUND INFORMATION

Certain scan matching and map alignment methods are described in the related art. The goal of scan matching or map alignment is to determine an aligning transformation between different scans of environmental sensors. This transformation represents a key step in creating a consolidated map from multiple scans and/or derived representations.

In some conventional approaches, the determination of the transformation is typically carried out in three steps: In a first step, feature vectors of two scans are generated. In a second step, feature matching is carried out, in which corresponding feature vectors of the two scans are assigned to one another. In a third step, the aligning transformation between the two scans is determined on the basis of this assignment.

### SUMMARY

An object of the present invention is to provide an improved method for aligning scans of environmental sensors. This object is achieved by a method for aligning scans of environmental sensors having the features of the independent claim. Advantageous developments are specified in the dependent claims.

A method for aligning scans of environmental sensors according to an example embodiment of the present invention comprises the following method steps. Scans of a first and a second environmental sensor are used. For each environmental sensor, a first scan recorded at a first point in time and a second scan of the same environment recorded at a second point in time following the first point in time are used. The first scan of the first environmental sensor and the first scan of the second environmental sensor are combined to form a first fused scan. The second scan of the first environmental sensor and the second scan of the second environmental sensor are combined to form a second fused scan. An aligning transformation between the first fused scan and the second fused scan is ascertained.

The environmental sensors are designed to scan an environment. The environmental sensors can, for example, be part of a motor vehicle, such as an autonomous motor vehicle. The environmental sensors can alternatively or additionally be arranged on the infrastructure side, for example in the region of a route. However, the environmental sensors can alternatively also be designed, for example, to scan an environment of a robot device. Thus, the method can be used in the context of creating maps, in particular maps for autonomous driving, or in connection with motion planning and/or motion execution of a robotic device, i.e., in the context of robot navigation.

In one example embodiment of the present invention, the first and second environmental sensors are designed to detect different modalities. The environmental sensors can, for example, in each case be designed as a camera, as a lidar device (light detection and ranging, or lidar for short) or as a radar device (radio detection and ranging, or radar for short). However, the environmental sensors can also be designed as microelectromechanical (MEMS) sensors, for example as ultrasonic sensors. In principle, the environmental sensors are not limited to specific modalities. Advantageously, scans of environmental sensors that are designed to detect different modalities can also be combined in order to ascertain the aligning transformation on the basis of the fused scans. However, it is also possible that the first environmental sensor and the second environmental sensor are designed to detect the same modalities. For example, both environmental sensors can be designed as cameras.

For each environmental sensor, a pair of scans is used, in each case consisting of scans of the same scene recorded or captured at two different points in time. The first scans of the first and second environmental sensors recorded at the first point in time are combined. The second scans of the first and second environmental sensors recorded at the second point in time are combined. The combination of the first scans and the combination of the second scans of the first and second environmental sensors can be referred to as early fusion scan matching since the scans in question are combined before the aligning transformation is ascertained. The aligning transformation is thus ascertained on the basis of the fused scans.

According to an example embodiment of the present invention, ascertaining the aligning transformation comprises establishing correspondences, within the framework of which feature vectors of the first and the second fused scan, which comprise information from both environmental sensors and preferably from different fused modalities, are assigned to one another (establishing point correspondences). In other words, the method can be referred to as early fusion scan matching since the input data from the environmental sensors are fused before generating features for finding point correspondences and thus before finding point correspondences. Subsequently, before the aligning transformation is ascertained, the initially concatenated feature vectors can be further processed in a neural network, such as a CNN, e.g., using a method such as FCGF (fully convolutional geometric features), whereby improved feature vectors can be available for ascertaining the aligning transformation.

Advantageously, improved scan matching results can be achieved through early fusion scan matching; i.e., a more precise aligning transformation can be ascertained since information from the scans of the different environmental sensors to be combined can, for example, complement one another. Overall, this results in a more accurate estimate of the aligning transformation, whereby higher-quality maps of the environment can be created. In addition, the additional computational effort is negligible due to the early integration of the input data or scans used by early fusion scan matching compared to conventional scan matching methods.

In one example embodiment of the present invention, the environmental sensors are extrinsically calibrated. Extrinsic calibration of the environmental sensors means that the environmental sensors are calibrated to one another, which advantageously makes a geometric match possible between the scans recorded by the first and second environmental sensors. In contrast, intrinsic calibration means that a sensor is calibrated to itself in order to achieve a geometric match between the measured data and the actual data. The extrinsic calibration has the advantage that the scans of the first and the second environmental sensors can be assigned a common coordinate system or that they have a common coordinate system.

In one example embodiment of the present invention, the first scans of the environmental sensors are used in the form of first grids and the second scans of the environmental sensors are used in the form of second grids, in each case comprising grid cells to which feature vectors are assigned. Combining the first scans and combining the second scans are in each case carried out by aggregating corresponding grid cells, wherein the aggregation of the grid cells comprises concatenating feature vectors of corresponding grid cells and assigning the concatenated feature vectors to form fused grid cells, whereby the fused scans are provided in the form of fused grids. The concatenation of feature vectors and the assignment of the feature vectors to form fused grid cells can also be referred to as an aggregation of corresponding grid cells to form fused grid cells.

A grid can also be referred to as a raster, and a grid cell can also be referred to as a raster cell. If the environmental sensors are extrinsically calibrated, the grid cells or feature vectors have a common coordinate system. The environmental sensors can, for example, be designed to provide scans in the form of point clouds. The point clouds can, for example, be transformed into grids within the framework of the method. However, the transformation of point clouds into grids is not mandatory; scans already available in the form of grids can also be used.

The grids can be designed as explicit or implicit grids. An explicit grid is designed to be two-dimensional or three-dimensional and comprises a definable number of grid cells for all dimensions. If, by contrast, additional feature vectors are present outside the explicit grid, it is possible to generate additional grid cells that comprise the additional feature vectors. The explicit grid, together with the additional grid cells, forms an implicit grid.

According to an example embodiment of the present invention, the aggregation of grid cells to form fused grid cells can, for example, be carried out according to the following rules. In one embodiment, if two grid cells to be aggregated comprise a first and a second feature vector, respectively, the fused grid cell is assigned a feature vector concatenated from the first and the second feature vector. In one embodiment, if only one of two grid cells to be aggregated comprises a first or second feature vector, the fused grid cell is assigned a feature vector concatenated from the first or the second feature vector and from a definable feature vector. In one embodiment, if two grid cells to be aggregated do not in each case comprise a feature vector, no feature vector is assigned to the fused grid cell.

In one example embodiment of the present invention, the grids of the scans of the first environmental sensor and the second environmental sensor have the same grid length. The grid length can also be referred to as the raster length and indicates the extent of the square or cubic grid cells that form the grid or raster. In this case, first and second grids of the first or second scans of the first and second environmental sensors can advantageously be combined directly with one another.

In an alternative embodiment of the present invention, a second grid length of the scans of the second environmental sensor corresponds to an integer multiple of a first grid length of the scans of the first environmental sensor. In this variant, the grids of the scans of the first environmental sensor are transformed in such a way that a transformed first grid length corresponds to the second grid length. Advantageously, grids that initially have different grid lengths can also be combined. Transforming a grid to a different grid length can be referred to as striding. One condition is that the second grid length is an integer multiple of the first grid length. This is necessary so that a plurality of entire grid cells having the first grid length can be fused into a transformed grid cell having the transformed grid length. For example, the second grid length can be twice the size of the first grid length. In the two-dimensional case, the transformed grid cell thus comprises four grid cells having the first grid length, which grid cells are arranged squarely in a 2×2 matrix and in total result in a transformed grid length that corresponds to the second grid length. In another example, the second grid length may be three times the first grid length. In the two-dimensional case, the transformed grid cell then comprises nine grid cells having the first grid length. The nine grid cells are arranged squarely in a 3×3 matrix and in total result in a transformed grid length that corresponds to the second grid length.

In one example embodiment of the present invention, a transformed grid cell having the transformed grid length comprises a number of grid cells having the first grid length that corresponds to a square or a cube of the integer multiple. If at least one of the grid cells that have the first grid length and are encompassed by the transformed grid cell comprises a feature vector, the at least one feature vector is assigned to the transformed grid cell. If a plurality of grid cells that have the first grid length and are encompassed by the transformed grid cell, in each case comprise a feature vector, the feature vectors can be transformed, for example by means of a neural network, such as a CNN, into a common vector, which is assigned to the transformed grid cell.

In one example embodiment of the present invention, a first scan recorded at the first point in time and a second scan recorded at the second point in time of at least a third environmental sensor are used. The first scan of the third environmental sensor is combined with the first fused scan to form a further first fused scan. The second scan of the third environmental sensor is combined with the second fused scan to form a further second fused scan. A further aligning transformation is ascertained between the further first fused scan and the further second fused scan.

In this variant, more than two environmental sensors are used for early fusion scan matching. The scans of the environmental sensors are combined iteratively, i.e., initially first and second scans are combined in order to obtain first and second fused scans; subsequently, the fused scans are in turn combined with the scans of the third environmental sensor in order to obtain further fused scans, wherein the first fused scan is combined with the first scan of the third environmental sensor and the second fused scan is combined with the second scan of the third environmental sensor.

In one example embodiment of the present invention, a first scan recorded at the first point in time and a second scan recorded at the second point in time of a fourth environmental sensor are additionally used. The iteration can now be continued by combining the further first fused scan with the first scan of the fourth environmental sensor and the further second fused scan with the second scan of the fourth environmental sensor in order to obtain an additional first fused scan and an additional second fused scan, respectively. In this case, an additional aligning transformation between the additional first fused scan and the additional second fused scan can be ascertained.

In one example embodiment of the present invention, the aligning transformation is ascertained using a neural network and on the basis of the fused scans. The neural network can, for example, be designed as a so-called convolutional neural network (CNN for short) or as a grid-based neural network. Such neural networks make it possible to aggregate spatial information and ascertain features, wherein high algorithmic performance compared to classical machine learning approaches can be achieved.

The method for aligning scans of environmental sensors according to the present invention is explained in detail below in conjunction with schematic figures.

### BRIEF DESCRIPTION OF THE DRAWINGS

FIG. 1 shows method steps of the method for aligning scans of environmental sensor, according to an example embodiment of the present invention.

FIG. 2 shows a combination of a first scan and a second scan to form a fused scan, according to an example embodiment of the present invention.

FIG. 3 shows the adjustment of a first scan before combining to form the fused scan, according to an example embodiment of the present invention.

### DETAILED DESCRIPTION OF EXAMPLE EMBODIMENTS

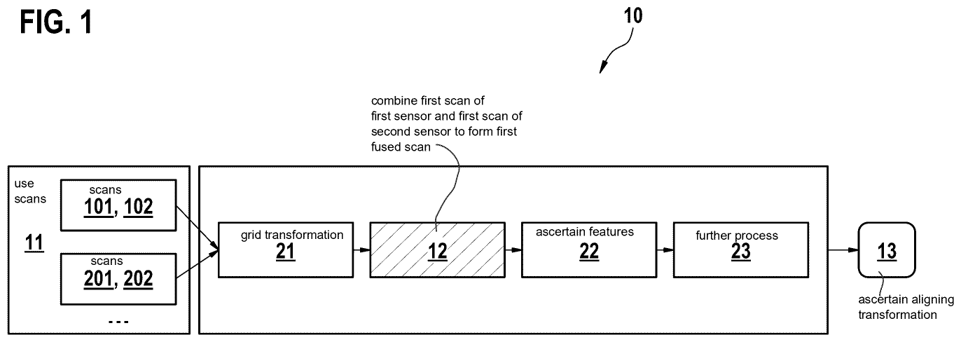

FIG. 1 schematically shows method steps 11, 12, 13, 21, 22, 23 of a method 10 for aligning scans 101, 102, 201, 202 of environmental sensors. The environmental sensors are in each case designed to scan an environment and provide scans 101, 102, 201, 202 of the environment. Preferably, the environmental sensors are designed to detect different modalities. Likewise, the environmental sensors are preferably extrinsically calibrated, although this is not mandatory. It is also not necessary that the environmental sensors are designed to detect different modalities.

By way of example, FIG. 1 shows that scans 101, 102, 201, 202 of two different environmental sensors are used within the framework of the method 10. A first environmental sensor is designed to record and provide scans 101, 102 of the environment. A second environmental sensor is designed to record and provide scans 201, 202 of the same environment. However, more than two different environmental sensors can also be used to record scans 101, 102, 201, 202 of the environment, wherein preferably all environmental sensors are designed to record different modalities and/or can be extrinsically calibrated.

The scans 101, 102, 201, 202 of the environmental sensors can, for example, be provided and used in the form of grids. However, this is not mandatory. Alternatively, the scans 101, 102, 201, 202 of the environmental sensors can also be provided and used in the form of point clouds. In this case, a grid transformation, within the framework of which point clouds are transformed into grids, is carried out in a first optional step 21.

Point clouds can also be called point clusters. A point cloud is understood to be a set of points in a vector space, which set of points can be created on the basis of sensor data and comprises, for example, objects in the environment that can be represented by means of a plurality of points. For example, point clouds that can be generated from lidar data comprise points at which a laser beam has been reflected. In contrast, a grid comprises grid cells to which feature vectors can be assigned depending on the distribution of the points in a point cloud and the modality of the associated environmental sensor.

In a first method step 11, the scans 101, 102, 201, 202 of the environmental sensors are used. A first scan 101 and a second scan 102 of the first environmental sensor and a first scan 201 and a second scan 202 of the second environmental sensor are used. Accordingly, first and second scans of any number of environmental sensors can be used. The first scans 101, 201 of the environmental sensors were recorded at a first point in time. The second scans 102, 202 of the environmental sensors were recorded at a second point in time, which follows the first point in time. After the optional grid transformation, the first scans 101, 201 of the environmental sensors are used in the form of first grids and the second scans 102, 202 of the environmental sensors are used in the form of second grids. The first and second grids in each case comprise grid cells to which feature vectors can be assigned.

In a second method step 12, the first scan 101 of the first environmental sensor and the first scan 201 of the second environmental sensor are combined to form a first fused scan. The second scan 102 of the first environmental sensor and the second scan 202 of the second environmental sensor are combined to form a second fused scan.

If first and second scans of at least a third environmental sensor are additionally used, an iterative combination of the scans can be carried out within the framework of the second method step 12, wherein a first scan of the third environmental sensor is combined with the first fused scan to form a further first fused scan and the second scan of the third environmental sensor is combined with the second fused scan to form a further second fused scan.

After the second method step 12, optional further processing of the fused scans can be carried out, e.g., using a method such as FCGF. This produces improved feature vectors.

After the second method step 12, in an optional second step 22, features of the first and second fused scans, or of the further first and further second fused scans can be ascertained and assigned to one another in order to ascertain corresponding feature vectors. In an optional third step 23, further processing of the fused scans can be carried out. However, further processing can also be omitted. The third step 23 can also be carried out before the second method step 12 and, for example, comprise the further processing of the fused scans.

In a third method step 13, an aligning transformation between the first fused scan and the second fused scan or a further aligning transformation between the further first fused scan and the further second fused scan is ascertained. An aligning transformation comprises a rotation and/or a transition between corresponding feature vectors of the first and second fused scans or the further first and the further second fused scans.

Thus, the method 10 is based on the idea of combining or linking the used scans 101, 102, 201, 202 before ascertaining the aligning transformation in order to obtain a more precise transformation. Scans 101, 102, 201, 202 of at least two different environmental sensors in an environment, which were recorded at two different points in time, are used. The scans 101, 102, 201, 202 of the different environmental sensors recorded at the same point in time are combined in order to obtain fused scans. The aligning transformation is then ascertained on the basis of the fused scans. The aligning transformation maps the first fused scan to the second fused scan. Since the first and second fused scans relate to the first and second points in time, respectively, the aligning transformation maps a state at the first point in time to a state at the second point in time. Thus, the method 10 is based on scan matching, wherein, in contrast to conventional scan matching methods, an early fusion of input data from a plurality of different environmental sensors is carried out.

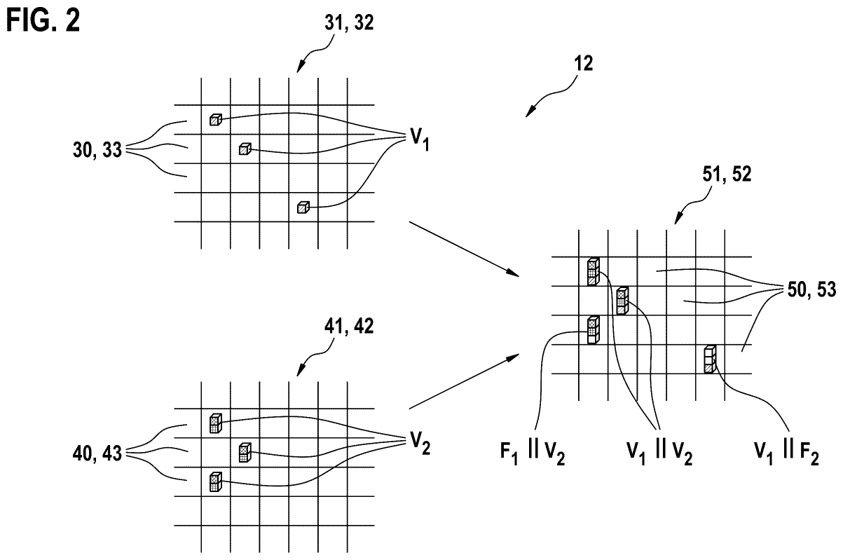

Combining the first scans 101, 201 and combining the second scans 102, 202 can in each case be carried out by aggregating corresponding grid cells 30, 33, 40, 43. The aggregation of the grid cells 30, 33, 40, 43 comprises concatenating feature vectors of corresponding grid cells 30, 33, 40, 43 and assigning the concatenated feature vectors to fused grid cells 50, 53, whereby the fused scans are provided in the form of fused grids 51, 52. FIG. 2 illustrates the second method step 12 of combining first and second scans 101, 102, 201, 202 to form fused scans 51, 52.

FIG. 2 by way of example shows only a first grid 31 having first grid cells 30 of an associated first scan 101 of the first environmental sensor and a first grid 41 having first grid cells 40 of an associated first scan 201 of the second environmental sensor, which are combined to form a common, first fused grid 51. Accordingly, in the second method step 12, a combination of a second grid 32 having second grid cells 33 of an associated second scan 102 of the first environmental sensor and a second grid 42 having second grid cells 43 of an associated second scan 202 of the second environmental sensor are carried out, which are combined to form a common, second fused grid 52.

The grids 31, 32, 41, 42 are merely exemplary and are designed to be two-dimensional; they can also be designed to be three-dimensional. In the present example, the first grids 31, 41 to be combined and the second grids 32, 42 to be combined also have the same grid length. A feature vector of a grid cell 30, 33, 40, 43 is schematically indicated in FIG. 2 by means of at least one cube arranged within the particular grid cell 30, 33, 40, 43. Grid cells 30, 33, 40, 33 to which no feature vector is assigned are shown in FIG. 2 as unoccupied grid cells 30, 33, 40, 43 without any entry.

The feature vectors V of the grid cells 30, 33, 40, 43 comprise a so-called feature dimension C, where 1≤C∈ [symbol] . By way of example, the grid 31, 32 of a scan of the first environmental sensor comprises a total of three grid cells 30, 33, each of which is assigned a first feature vector V₁, while all remaining grid cells 30, 33 comprise, by way of example, no entry. By way of example, the first feature vectors V₁ have the feature dimension C₁=1. For this reason, each first feature vector V₁ is represented by means of a cube. The grid 41, 42 of a scan of the second environmental sensor comprises, by way of example, a total of three grid cells 40, 43, each of which is assigned a second feature vector V₂, while all remaining grid cells 40, 43 comprise, by way of example, no entry. By way of example, the second feature vectors V₂ have the feature dimension C₁=2. For this reason, each second feature vector V₂ is represented by means of two cubes arranged on top of one another.

Aggregating the first and second feature vectors V₁, V2 is carried out as follows, by way of example: If two grid cells 30, 33, 40, 43 to be aggregated in each case comprise a first and second feature vector V₁, V₂, respectively, a fused grid cell 50, 53 is assigned a concatenated feature vector V₁, ∥V₂. In FIG. 2, two of the grid cells 30, 33 of the grid 31, 32 of the first environmental sensor in each case comprise a first feature vector V₁ and two corresponding grid cells 40, 43 of the grid 41, 42 of the second environmental sensor in each case comprise a second feature vector V₂. By aggregating the corresponding grid cells 30, 33, 40, 43, the associated fused grid cells 50, 53 in each case comprise a concatenated feature vector V1∥V₂ having the concatenated feature dimension C₁+C₂=3. In the fused scan 51, 52, the two concatenated feature vectors V₁∥V₂ are in each case illustrated by means of three cubes, wherein the number of cubes represents the concatenated feature dimension.

If only one of two grid cells 30, 33, 40, 43 to be aggregated comprises a first or second feature vector V₁, V₂, the fused grid cell 50, 53 is assigned a feature vector F₁∥V₂, F₂∥V₁ concatenated from the first or second feature vector V₁, V₂ and from a definable feature vector F₁, F₂. In FIG. 2, one of the grid cells 40, 43 of the grid 41, 42 of the second environmental sensor comprises a second feature vector V₂. However, by way of example, a corresponding grid cell 30, 33 of the grid 31, 32 of the first environmental sensor does not comprise a feature vector. By aggregating the corresponding grid cells 30, 33, 40, 43, the associated fused grid cell 50, 53 comprises a concatenated feature vector F₁∥V₂, where F₁ is a first definable feature vector, which can, by way of example, comprise the value zero or another definable value. The feature dimension of the first definable feature vector F₁ corresponds to the feature dimension of first feature vectors V₁ C₁=1.

In addition, in FIG. 2, one of the grid cells 30, 33 of the grid 31, 32 of the first environmental sensor comprises a first feature vector V₁. However, by way of example, a corresponding grid cell 40, 43 of the grid 41, 42 of the second environmental sensor does not comprise a feature vector. By aggregating the corresponding grid cells 30, 33, 40, 43, the associated fused grid cell 50, 53 comprises a concatenated feature vector V₁∥F₂, where F₂ is a second definable feature vector, which can, by way of example, comprise the value zero or another definable value. The feature dimension of the first definable feature vector F₂ corresponds to the feature dimension of second feature vectors V₂ C₂=2. The concatenated feature vectors F₁∥V₂ and V₁∥F₂ have the feature dimension C₁+C₂=3. If two grid cells 30, 33, 40, 43 to be aggregated do not in each case comprise a feature vector, no feature vector is assigned to the fused grid cell 50, 53.

As a result, the information from the first grids 31, 41 and the information from the second grids 32, 42 in each case can be provided in a combined manner in a first and second fused grid 51, 52, respectively. This combination of information from scans 101, 102, 201, 202 of different environmental sensors for different points in time of the same scene is carried out before ascertaining the aligning transformation. For this reason, the method according to FIG. 1 can also be referred to as early fusion scan matching.

In the exemplary embodiment of the aggregation of the grid cells 30, 33, 40, 43 according to FIG. 2, the grid cells 30, 33, 40, 43 to be aggregated have the same grid length, i.e., an edge length of the squarely arranged grid cells 30, 33, 40, 43 is identical for the grid cells 30, 33, 40, 43 of the grids of the scans 101, 102, 201, 202 of the first and second environmental sensors. However, this is not mandatory.

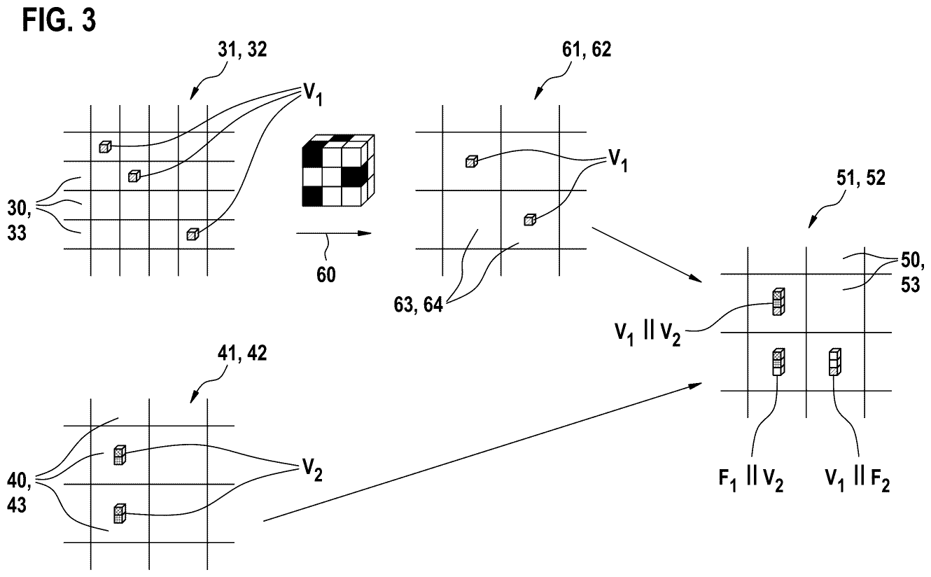

FIG. 3 illustrates the second method step 12 of combining first and second scans 101, 102, 201, 202 to form fused scans 51, 52 in the case that a second grid length of the scans 201, 202 of the second environmental sensor corresponds to an integer multiple of a first grid length of the scans 101, 102 of the first environmental sensor. By way of example, the second grid length of the grid 41, 42 of the second environmental sensor is twice as large as the first grid length of the grid 31, 32 of the first environmental sensor. In this case, the grids of the scans 101, 102 of the first environmental sensor are transformed in such a way that a transformed first grid length corresponds to the second grid length. In the exemplary embodiment of FIG. 3, a grid transformation 60 of the grid 31, 32 of the first environmental sensor is thus carried out, whereby a transformed grid 61, 62 is obtained, whose transformed grid cells 63, 64 have the same grid length as the grid cells 40, 43 of the grid 41, 42 of the second environmental sensor. Due to this alignment of the grid lengths, the grid 41, 42 of the second environmental sensor and the transformed grid 61, 62 can be combined to form a fused grid 51, 52. As a result, the information from the first grids 31, 41 and the information from the second grids 32, 42 can in each case be provided in a combined manner in a first and second fused grid 51, 52, respectively, although they initially have different grid lengths.

The transformed grid cells 63, 64, which have the transformed grid length, comprise a number of grid cells 30, 33 having the first grid length that corresponds to a square of the integer multiple. In the case of three-dimensional grids, the transformed grid cells 63, 64 comprise a number of grid cells 30, 33 having the first grid length that corresponds to a cube of the integer multiple. During grid transformation, at least one first feature vector V₁ is assigned to a transformed grid cell 63, 64 if the transformed grid cell 63, 64 having the transformed grid length comprises at least one grid cell 30, 33 which has the first grid length and to which a first feature vector V₁ is assigned.

What is claimed is:

1. A method for aligning scans of environmental sensors, comprising the following steps:
using scans of a first environmental sensor and a second environmental sensor, wherein, for each of the first and second environment sensors, a first scan recorded at a first point in time and a second scan of the same environment recorded at a second point in time following the first point in time are used;
combining the first scan of the first environmental sensor and the first scan of the second environmental sensor to form a first fused scan, and combining the second scan of the first environmental sensor and the second scan of the second environmental sensor to form a second fused scan; and
ascertaining an aligning transformation between the first fused scan and the second fused scan.

2. The method according to claim 1, wherein the first and second environmental sensors are configured to detect different modalities, relative to one another.

3. The method according to claim 1, wherein the first and second environmental sensors are extrinsically calibrated.

4. The method according to claim 1, wherein the first scan of each of the first and second environmental sensor is in the form of a first grid and the second scan of each of the first and second environmental sensors is in the form of a second grid, wherein each of the first grids and the second grids includes grid cells to which feature vectors are assigned, wherein the combining the first scans and the combining the second scans are carried out by aggregating corresponding grid cells, wherein the aggregating of the corresponding grid cells includes concatenating the feature vectors of the corresponding grid cells and assigning the concatenated feature vectors to form fused grid cells, so that the fused first scan and the fused second scan are provided in the form of fused grids.

5. The method according to claim 4, wherein, when the grid cells to be aggregated include a first feature vector and a second feature vector, respectively, the fused grid cell is assigned a feature vector concatenated from the first and the second feature vector.

6. The method according to claim 5, wherein, when only one of the grid cells to be aggregated includes the first or second feature vector, the fused grid cell is assigned a feature vector concatenated from the first or the second feature vector and from a definable feature vector.

7. The method according to claim 4, wherein, when the grid cells to be aggregated do not include a feature vector, no feature vector is assigned to the fused grid cell.

8. The method according to claim 4, wherein: (i) the first and second grids of the first and second scans of the first environmental sensor and the second environmental sensor have the same grid length, or (ii) a second grid length of the first and second scans of the second environmental sensor corresponds to an integer multiple of a first grid length of the first and second scans of the first environmental sensor, and wherein when the second grid length corresponds to the integer multiple of the first grid length, the first and second grids of the first and second scans of the first environmental sensor are transformed in such a way that a transformed first grid length corresponds to the second grid length.

9. The method according to claim 8, wherein each of the transformed grid cells having the transformed grid length includes a number of grid cells having the first grid length that corresponds to a square or a cube of the integer multiple, and wherein when at least one of the grid cells that have the first grid length and are encompassed by the transformed grid cell includes a feature vector, the feature vector is assigned to the transformed grid cell.

10. The method according to claim 1, wherein:
a first scan of a third environmental sensor recorded at the first point in time and a second scan of the third environmental sensor recorded at the second point in time are used,
the first scan of the third environmental sensor is combined with the first fused scan to form a further first fused scan,
the second scan of the third environmental sensor is combined with the second fused scan to form a further second fused scan,
wherein a further aligning transformation is ascertained between the further first fused scan and the further second fused scan.

11. The method according to claim 1, wherein the aligning transformation is ascertained using a neural network and based on the first and second fused scans.
